(19) United States
(12) Patent Application Publication
(10) Pub. No.: US 2018/0142776 A1
(43) Pub. Date: May 24, 2018

(54) AIR COOLING DEVICE FOR A ROTATING MEMBER OF A VEHICLE

(71) Applicant: GM Global Technology Operations LLC, Detroit, MI (US)

(72) Inventors: Avissai Alcantara Burguete, Rochester Hills, MI (US); Arthur C. Valverde, Macomb, MI (US); Julia E. Considine, Brighton, MI (US)

(21) Appl. No.: 15/357,224

(22) Filed: Nov. 21, 2016

(51) Int. Cl. F16H 57/04; F16C 3/02; F02B 61/06; F01N 3/10; F04D 29/28

(52) U.S. Cl. CPC F16H 57/0416; F16C 3/02; F04D 29/282; F01N 3/10; F02B 61/06

(57) ABSTRACT

An air cooling device facilitates the cooling and/or thermal protection of a rotating member of a vehicle exposed to a proximately located heat source of the vehicle. The air cooling device may include a plurality of airfoils projecting radially outward from the rotating member for forming a flowing, thermally insulating, layer of air about the rotating member.

### INTRODUCTION

The present disclosure relates to a rotating member of a vehicle that may be subjected to thermal inputs and, more particularly, to a prop or drive shaft having a cooling device for reducing temperature extremes on the shaft exterior.

Rotating shafts, particularly prop or drive shafts used in the propulsion systems of a motor vehicle are often constructed of thin-walled, hollow, tubing supported for rotation at the shaft ends (and in some applications at intermediate locations) by lubricated bearing assemblies. In order to balance the shaft, as well as to reduce noise and vibration (“NVH”) emanating therefrom, various types of damping and insulative devices may be installed in or on the shaft. The thin walls of the shaft, the bearings, dampers and insulating devices are often ill suited for the deleterious effects of thermal extremes, such as those that may occur in or near an internal combustion engine or the exhaust system of the combustion engine. In low speed traffic and at idle, under-vehicle devices such as catalytic convertors may cause shafts to reach temperatures in excess of 200 C which may lead to accelerated wear of the described components.

It is known to address high thermal loads utilizing heat shields, special high-temperature coatings and high temperature shaft materials. These solutions, while effective, are both expensive and may add to vehicle weight. It is desirable to provide a system for cooling a rotatable shaft that dispenses with such high cost, high weight options.

### SUMMARY

In one exemplary embodiment of the present disclosure, an air cooling device facilitates the cooling and/or thermal protection of a rotating member of a vehicle exposed to a proximately located heat source of the vehicle. The air cooling device may include a plurality of airfoils projecting radially outward from the rotating member for forming a flowing, thermally insulating, layer of air about the rotating member.

In another embodiment, a vehicle includes a combustion engine, an exhaust system, a drive shaft, and a plurality of blades. The exhaust system is operatively engaged to, and projects rearward from, the combustion engine. The drive shaft extends along a rotation axis, and is proximate to the exhaust system. The plurality of blades each project radially outward from the drive shaft and are spaced circumferentially from adjacent blades of the plurality of blades. The plurality of blades provide a layer of flowing air about a rearward portion of the drive shaft to thermally insulate the drive shaft from a segment of the exhaust system proximate to the rearward portion when the drive shaft is rotating.

The above features and advantages and other features and advantages of the disclosure are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic of a vehicle utilizing an air cooling device for cooling a rotating member as one, non-limiting, exemplary embodiment in accordance with the present disclosure;

FIG. 2 is a perspective view of a drive shaft as one example of the rotating member supporting the air cooling device and proximate to an exhaust system, and taken from circle 2 of FIG. 1;

FIG. 3 is an enlarged, partial, perspective view of the drive shaft with the air cooling device; and

FIG. 4 is a front view of the air cooling device.

### DETAILED DESCRIPTION

The following description is merely exemplary in nature and is not intended to limit the present disclosure, its application or uses. It should be understood that throughout the drawings, corresponding reference numerals indicate like or corresponding parts and features.

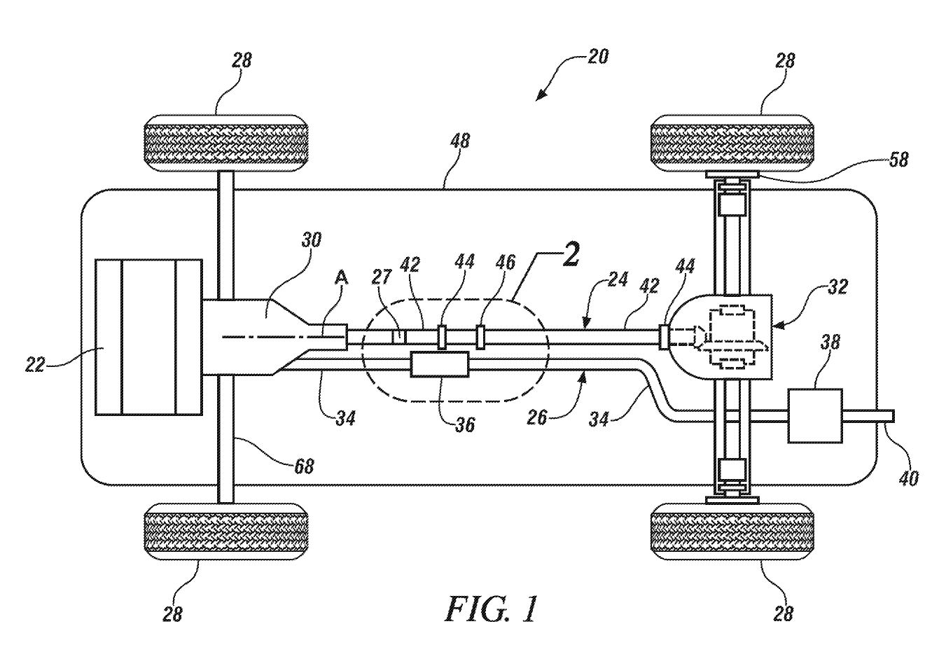

Referring to FIG. 1, a non-limiting, exemplary, embodiment of a vehicle 20 is illustrated. The vehicle 20 may include a propulsion source 22 that may be a combustion engine, a rotating member 24 that may be a drive shaft, a heat source 26 that may be an exhaust system, an air cooling device 27, and a plurality of wheels 28 (i.e., four illustrated). In one example, the combustion engine 22 may be coupled to a transmission 30 for controlling torque and rotational speed output. The drive shaft 24 rotates about axis A, and may axially extend between, and is coupled for rotation to, the output of the transmission 30 and, in one example, a rear differential 32. The rear differential 32 may extend between two rear wheels of the plurality of wheels 28. Through the transmission 30, drive shaft 24, and rear differential 32, the engine 22 drives at least one of the wheels 28, thereby propelling the vehicle 20 upon a surface (e.g., road). The vehicle 20 may be a racing vehicle, a sedan, a truck, a van, a sport utility vehicle, or any other self-propelled conveyance suitable for transporting a burden. Other examples of a heat source 22 may be the combustion engine, the interaction of brake pads upon brake calipers, and others. Other examples of a rotating member 24 may include the brake calipers, an axle of the rear differential 32, and other members.

In one embodiment where the combustion engine 22 is generally located at the front of the vehicle 20, the exhaust system 26 may include a rearward extending pipe 34 interposed by a catalytic converter 36 and a muffler 38 of the exhaust system 26. The pipe 34 facilitates the rearward flow of hot exhaust gases from the combustion engine 22, through the catalytic converter 36, then through the muffler 38 and out an end portion 40 (i.e., tail pipe) proximate to a rear portion of the vehicle 20.

In one embodiment, the drive shaft 24 may include a tube 42, at least one bearing 44 and/or at least one vibration and/or noise isolator 46. The tube 42 may be a thin-walled tube for weight reduction, and generally extends between, and is coupled to, the transmission 30 and the rear differential 32. The bearings 44 may be supported by a support structure and/or chassis 48 of the vehicle 20, and are adapted to rotationally support the tube 42. The isolator 46 may be any variety of isolators known by one skilled in the art, and is adapted to reduce vibration and/or noise.

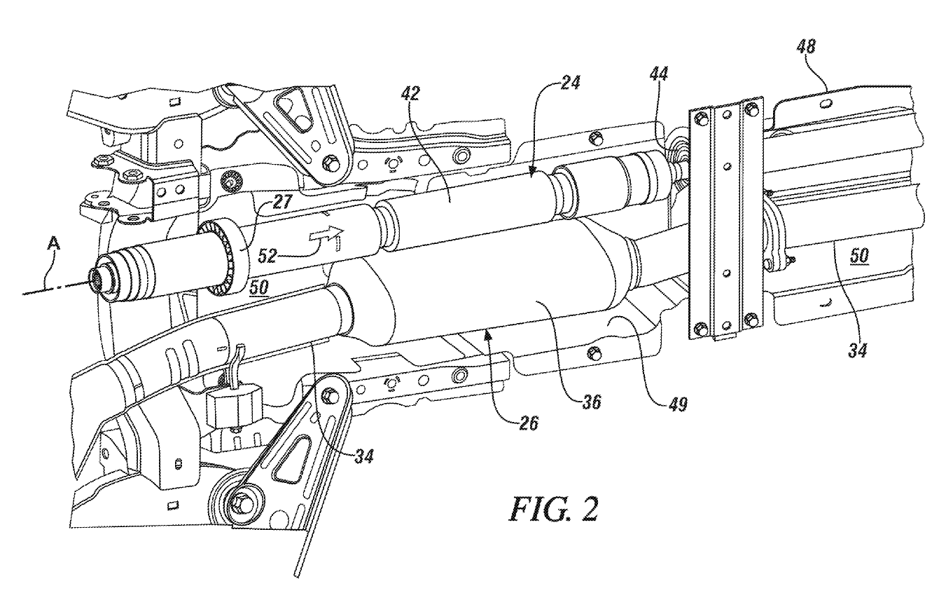

Referring to FIGS. 1 and 2, the chassis 48 may be, or may include, a wall 49 that may define an inverted alcove or tunnel 50. In one example, the wall 49 may be a contoured floor pan that may be thermally insulated and/or covered with a noise attenuating layer for the comfort of the operator of the vehicle 20. The drive shaft 24 may be substantially located in the alcove 50. Similarly, the exhaust system 26 may be, at least in-part, located in the alcove 50, and at least a segment of the exhaust system 26 is proximate to at least a portion of the drive shaft 24. In one example, the segment may be the catalytic converter 36 that may be located in close proximity to the tube 42, bearing(s) 44 and/or isolator 46 of the drive shaft 24. Thus, the tube 42, bearing(s) 44 and/or isolator 46 of the drive shaft 24 may be exposed to high heat loads dissipating from the pipe 34 and/or catalytic converter 36 without use of the air cooling device 27. The confines created by the wall 49 and the location of the drive shaft 24 in the alcove 50 may assist in limiting dissipation of the exhaust heat causing the drive shaft 24 to experience elevated temperatures.

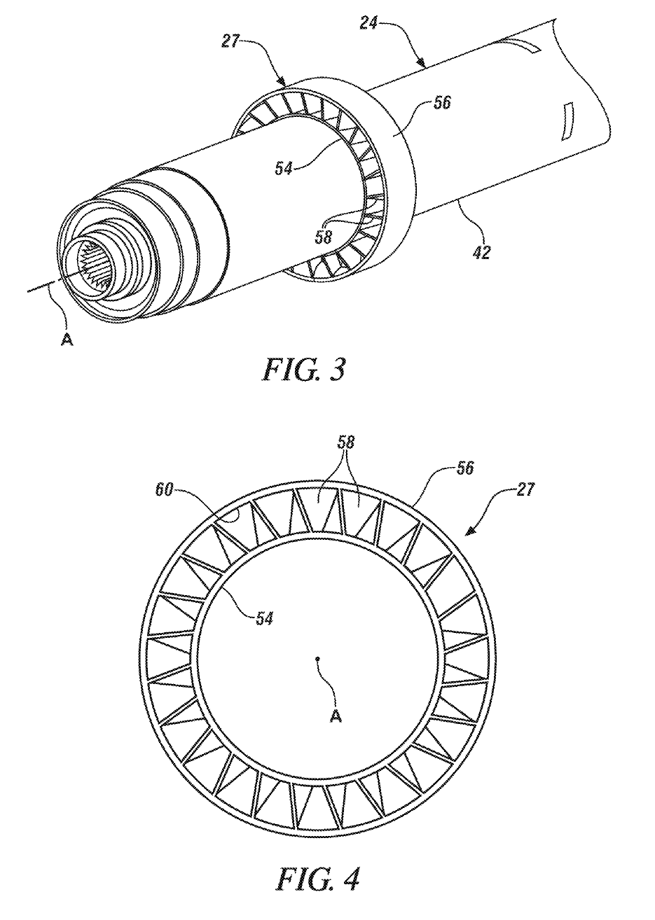

Referring to FIGS. 2 and 3, the air cooling device 27 is adapted to rotate with the drive shaft 24, thereby creating a blanking flow of air that may generally be annular in shape. This flow of air may function to cool the drive shaft 24 via thermal convection and/or may form a blanketing layer of air (see arrow 52 in FIG. 2) that functions to thermally insulate the drive shaft 24 from the exhaust system 26. The cooling device 27 may be fixed to the tube 42 of the drive shaft 24, and may generally be located upstream and forward of the portion(s) of the drive shaft 24 that benefit from the blanketing layer of cooling air 52.

Referring to FIGS. 3 and 4, the air cooling device 27 may include an inner sleeve 54, an outer sleeve 56, and a plurality of airfoils or blades 58. The inner sleeve 54 may be cylindrical and is engaged or fixed to the tube 42 of the drive shaft 24. Similarly, the outer sleeve 56 may be cylindrical, is concentrically located to, and is spaced radially outward from the inner sleeve 54. Each one of the plurality of airfoils 58 extend radially between and are engaged to the inner and outer sleeves 54, 56, and are circumferentially spaced from the adjacent airfoils. In one embodiment, the outer sleeve 56 may include a circumferentially extending surface 60 that faces radially inward and is attached to the plurality of airfoils 58. The contour of the surface 60 may be any variety of contours, which may be dependent upon manufacturing cost and/or the desired shape and velocity of the downstream, blanketing, layer of air 52. Examples of surface contours may be cylindrical and conical.

In one example, the air cooling device 27 may not include an outer sleeve 56, and instead, each airfoil 58 may project radially outward to end portions that may be distal end portions. The surface 60 may be carried by the chassis wall 49, and may in-part define the alcove 50. In this example, the surface 60 may extend circumferentially with respect to axis A, but may not be continuous. The end portions of the airfoils 58 are in close proximity to and move with respect to the surface 60. That is, each airfoil or blade 58 may span radially between the drive shaft 24 and the surface 60 during an interval of time when the drive shaft 24 is rotating about axis A. In another example, the air cooling device 27 may not include an inner sleeve 54, and instead, each airfoil 58 may be engaged to, and projects radially outward from, the tube 42 or other rotating component of the drive shaft 24.

The contour of one or both of the inner and outer sleeves 54, 56 and the contour (e.g., pitch angle, chord line, twist, tilt, etc.) of each airfoil 58 may be optimized to provide the desired layer of air 52 characteristics. Such contouring of the airfoils 58 may include an airfoil twist, wherein the angle of attack may be greater at the airfoil root than the radially outward location of each airfoil. In this example, the angle of attack is greater at radially inward portions of the airfoil 58 because the speed of the radially inward portions is less than the speed of the radially outward portions. That is, by twisting each airfoil 58, the velocity of the air 52 downstream of the device 27 may be substantially the same regardless of the radial location. In any event, various contours of the air cooling device 27 may be chosen as is typically known to one with skill in the art, and with regard to specific applications including temperature design limits, rotational speeds, and other factors.

Advantages and benefits of the present disclosure include a rotating member that operates at lower temperatures, and a member that may not require other temperature resistant solutions such as heat reflective paint, heat shields, high temperature resistant rubbers, and high temperature resistant bearings. Other advantages include a simpler, more robust, and cost effective design.

While the disclosure is described with reference to exemplary embodiments, it will be understood by those skilled in the art that various changes may be made and equivalents may be substituted for elements thereof without departing from the scope of the invention. In addition, many modifications may be made to adapt a particular situation or material to the teachings herein without departing from the essential scope thereof. Therefore, it is intended that the invention not be limited to the particular embodiments disclosed, but that the invention will include all embodiments falling within the scope of the application.

What is claimed is:

1. An air cooling device for a rotating member of a vehicle exposed to a proximate heat source of the vehicle, the air cooling device comprising:
a plurality of airfoils projecting radially outward from the rotating member for forming a flowing, thermally insulating, layer of air about the rotating member.

2. The air cooling device set forth in claim 1 further comprising:
an annular surface spaced from and opposed to the rotating member, wherein each one of the plurality of airfoils span radially between the annular surface and the rotating member.

3. The air cooling device set forth in claim 2, wherein the annular surface is carried by a circumferentially continuous sleeve, and the plurality of airfoils are engaged to the sleeve.

4. The air cooling device set forth in claim 2, wherein the annular surface is cylindrical.

5. The air cooling device set forth in claim 2, wherein the annular surface is conical.

6. The air cooling device set forth in claim 1, wherein the rotating member is a drive shaft.

7. The air cooling device set forth in claim 6, wherein the heat source is an exhaust system.

8. The air cooling device set forth in claim 1, wherein each one of the plurality of blades are twisted.

9. A vehicle comprising:
a combustion engine;
an exhaust system operatively engaged to and projecting rearward from the combustion engine;
a drive shaft extending along a rotation axis, and proximate to the exhaust system; and
a plurality of blades, wherein each blade projects radially outward from the drive shaft and is spaced circumferentially from adjacent blades of the plurality of blades, wherein the plurality of blades provide a layer of flowing air about a rearward portion of the drive shaft to thermally insulate the drive shaft from a segment of the exhaust system proximate to the rearward portion when the drive shaft is rotating.

10. The vehicle set forth in claim 9 further comprising:
a support structure defining an alcove, wherein the rearward portion is in the alcove.

11. The vehicle set forth in claim 9, wherein the segment is a catalytic converter.

12. The vehicle set forth in claim 9 further comprising:
a surface facing radially inward and extending at least in-part circumferentially about the drive shaft, wherein each one of the plurality of blades span radially between the drive shaft and the surface in an interval of time when the drive shaft is rotating.

13. The vehicle set forth in claim 12 further comprising:
a support structure including the surface.

14. The vehicle set forth in claim 12 further comprising:
a circumferentially continuous sleeve including the surface.

15. The vehicle set forth in claim 14, wherein each one of the plurality of blades span radially between the drive shaft and the sleeve.

16. The vehicle set forth in claim 15, wherein each one of the plurality of blades are engaged to the surface.

17. The vehicle set forth in claim 12, wherein the surface is cylindrical.

18. The vehicle set forth in claim 12, wherein the surface is conical.

19. The vehicle set forth in claim 9, wherein each one of the plurality of blades are twisted.
